(19) United States
(12) Patent Application Publication
(10) Pub. No.: US 2023/0267012 A1
(43) Pub. Date: Aug. 24, 2023

(54) SYSTEM AND METHOD FOR API RESOURCE PREDICTION

(71) Applicant: Jio Platforms Limited, Ahmedabad (IN)

(72) Inventors: Gaurav DUGGAL, Hyderabad (IN); Abhishek FARKADE, Pune (IN); Sapna THAKKAR, Thane (IN); Omkar CHAVAN, Mumbai (IN); Sanjay PRAJAPATH, Mumbai (IN); Swapnil MASUREKAR, Mumbai (IN); K Mohammed ASIF, Hyderabad (IN)

(73) Assignee: Jio Platforms Limited, Ahmedabad (IN)

(21) Appl. No.: 18/171,689

(22) Filed: Feb. 21, 2023

(30) Foreign Application Priority Data
Feb. 22, 2022 (IN) 202221009466

(51) Int. Cl. G06F 9/50; G06N 20/00

(52) U.S. Cl. CPC G06F 9/5055; G06N 20/00

(57) ABSTRACT

The present disclosure provides a system and method for utilizing an application programming interface (API) for handling multiple requests/models from various users. The API uses a machine learning (ML) model for processing the various requests and producing a plurality of trained models. The system is resilient to a race condition and incorporates an optimized random access memory (RAM) usage. Further, the system efficiently manages the limited available resources by loading and unloading the machine learning models based on their usage, thus maximizing the throughput of the API.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for model serving that integrate artificial intelligence (AI) with machine learning (ML) via an application programming interface (API). More particularly, the present disclosure relates to a system and a method that utilizes an API based prediction for resource efficient implementation that efficiently manages a random access memory (RAM) usage.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Application programming interfaces (APIs) are communication mechanisms between services. An API lifecycle is usually driven by an API provider (who may be responding to consumer requests). APIs may exist in various versions, software lifecycle states and are frequently developed like any software by API developers using an integrated development environment (IDE). After a successful test within an IDE, a particular API is usually deployed in a test/quality landscape for providing services. Further, APIs are also used with artificial intelligence (AI) and machine learning (ML) for providing user specific solutions. ML models are mathematical models used to find patterns and predictions in input data via optimization, training mechanisms. As the services grow and the number of APIs increase, scaling of APIs for handling multiple user requests becomes inefficient and inaccurate.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method to efficiently manage a random access memory (RAM) of a server by loading large files in a common base manager class instead of loading them into each worker subprocesses.

It is an object of the present disclosure to provide a system and a method that utilizes a versioning logic mechanism that provides an updated machine learning (ML) model while serving an inference request.

It is an object of the present disclosure to provide a system and a method that utilizes a least recently used (LRU) technique based caching mechanism which reduces an extra loading time by keeping most recently used model in the queue and prevents most used models from reloading.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for resource prediction. The system may be operatively coupled with a memory that stores instructions to be executed by the processor. The processor may receive one or more requests from one or more computing devices. One or more users may operate the one or more computing devices. The received one or more requests may be based on a training of one or more models via a machine learning (ML) engine operatively coupled to the processor. The processor may determine at least recently used trained model from the one or more trained models and unload a plurality of least used models from the one or more trained models based on the received one or more requests. The processor may utilize a caching mechanism to optimize a memory space associated with the memory by selectively loading the at least recently used trained model. The processor may predict, via the at least recently used trained model from the one or more trained models, prediction based on the predicted resource data.

In an embodiment, the processor may be configured to utilize a versioning logic mechanism to determine the at least recently used trained model from the one or more trained models and process the received one or more requests.

In an embodiment, the processor may be configured to utilize a least recently used (LRU) technique as the caching mechanism to optimize the memory space.

In an embodiment, the memory may be a random access memory (RAM) for storing the one or more trained models.

In an embodiment, the processor may include a base manager to store one or more trained models and enable one or more parallel processes to utilize the one or more trained models.

In an embodiment, the processor may be configured with a common loading functionality for loading the one or more trained models.

In an embodiment, the base manager may be configured to use a race condition avoidance solution to prevent a read or write operation of the one or more parallel processes in a directory.

In an embodiment, the common loading functionality may be configured with a multi-processing lock functionality to prevent the one or more parallel processes from utilizing the one or more trained models simultaneously.

In an embodiment, the processor may be configured with a conditional lock functionality to process, in a successive order, at least a model from the one or more trained models based on the received one or more requests.

In an aspect, the present disclosure relates to a method for resource prediction. The method may include receiving, by a processor, one or more requests from one or more computing devices. The received one or more requests may be based on a training of one or more models via an ML engine. The method may include determining by the processor, at least recently used trained model from one or more trained models and unloading a plurality of least used models from the one or more trained models based on the received one or more requests. The method may include utilizing, by the processor, a caching mechanism to optimize a memory space associated with the memory by selectively loading the at least recently used trained model. The method may include predicting, by the processor, via the at least recently used trained model from the one or more trained models, resource data based on the optimized memory space. The method may include enabling, by the processor, the resource prediction based on the predicted resource data.

In an embodiment, the method may include utilizing by the processor, a versioning logic mechanism for determining the at least recently used trained model from the one or more trained models and processing the received one or more requests.

In an embodiment, the method may include utilizing, by the processor, a least recently used (LRU) technique as the caching mechanism to optimize the memory space.

In an embodiment, the method may include recording, by the processor, the one or more trained models, and enabling, by the processor, one or more parallel processes to utilize the one or more trained models.

In an embodiment, the method may include utilizing, by the processor, a common loading functionality for loading the one or more models.

In an embodiment, the method may include utilizing, by the processor, a race condition avoidance solution to prevent a read or write operation of the one or more parallel processes in a directory.

In an embodiment, the common loading functionality may include a multi-processing lock functionality to prevent the one or more parallel processes from utilizing the one or more trained models simultaneously.

In an embodiment, the method may include utilizing, by the processor, a conditional lock functionality to process, in a successive order, at least a model from the one or more trained models based on the received one or more requests.

In an aspect, the present disclosure relates to a user equipment (UE) for resource prediction. The UE may include one or more processors communicatively coupled to a processor in a system. The one or more processors may be coupled with a memory. The memory may store instructions to be executed by the one or more processors and may cause the one or more processors to transmit one or more requests to the processor via a network. The processor may be configured to receive the one or more requests from the UE. The received one or more requests may be based on a training of one or more models via an ML engine operatively coupled to the processor. The processor may determine at least recently used trained model from the one or more trained models and unload a plurality of least used models from the one or more trained models based on the received one or more requests. The processor may utilize a caching mechanism to optimize a memory space associated with a memory of the processor by selectively loading the at least recently used trained model. The processor may predict, via the at least recently used trained model from the one or more trained models, prediction based on the predicted resource data.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system (110), in accordance with an embodiment of the present disclosure.

FIG. 2 illustrates an exemplary block diagram (200) of a proposed system (110), in accordance with an embodiment of the present disclosure.

FIG. 3 illustrates an exemplary representation (300) of a high level architecture of an application programming interface (API), in accordance with an embodiment of the present disclosure.

FIG. 4 illustrates an exemplary representation (400) of a flow diagram for a least recently used (LRU) caching mechanism, in accordance with an embodiment of the present disclosure.

FIG. 5 illustrates an exemplary representation (500) of a flow diagram for a common loading functionality, in accordance with an embodiment of the present disclosure.

FIG. 6 illustrates an exemplary representation (600) of a flow diagram for a method depicting an execution process utilized by the API, in accordance with an embodiment of the present disclosure.

FIG. 7 illustrates an exemplary computer system (700) in which or with which embodiments of the present disclosure may be utilized.

The foregoing shall be more apparent from the following more detailed description of the disclosure.

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

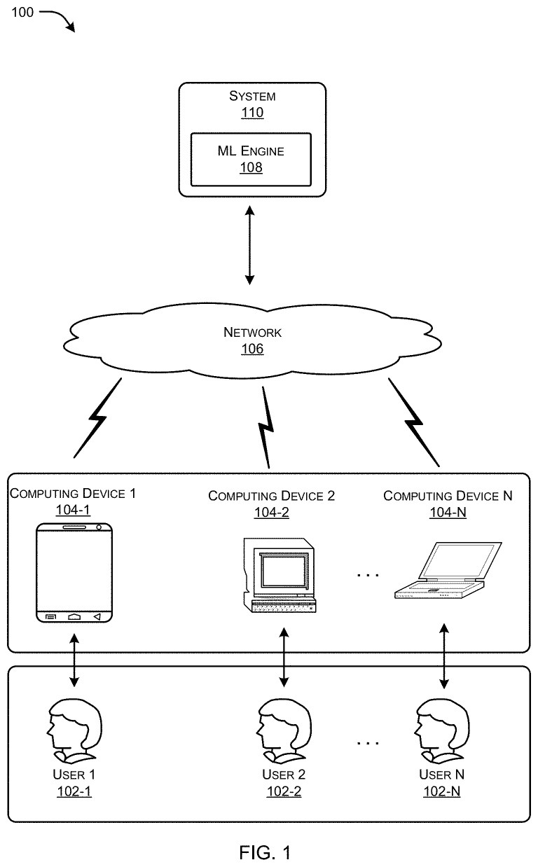

The various embodiments throughout the disclosure will be explained in more detail with reference to FIGS. 1-7.

FIG. 1 illustrates an exemplary network architecture (100) of a proposed system (110), in accordance with an embodiment of the present disclosure.

As illustrated in FIG. 1, the network architecture (100) may include a system (110). The system (110) may be implemented as an application programming interface (API) for resource efficient implementation. The system or the API (110) may be connected to one or more computing devices (104-1, 104-2 . . . 104-N) via a network (106). The one or more computing devices (104-1, 104-2 . . . 104-N) may be interchangeably specified as a user equipment (UE) (104) and be operated by one or more users (102-1, 102-2 . . . 102-N). Further, the one or more users (102-1, 102-2 . . . 102-N) may be interchangeably referred as a user (102) or users (102). The system (110) may include a machine learning (ML) engine (108) for generating a plurality of trained models based on the requests of the user (102).

The computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from a user (102) such as a touch pad, touch-enabled screen, electronic pen, and the like may be used. A person of ordinary skill in the art will appreciate that the computing devices (104) may not be restricted to the mentioned devices and various other devices may be used.

The network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (110) may receive one or more requests from users (102) via the computing devices (104). In an exemplary embodiment, the one or more requests may be based on processing of data provided by the users (102) via the ML engine (108). The data may include pre-processing requests and post-processing requests to be handled by the system (110). In an exemplary embodiment, the system (110) may include a load balancing feature for balancing the one or more requests received from the users (102).

In an embodiment, the system (110) may utilize the ML engine (108) to generate one or more trained models based on the data provided the users (102). In an exemplary embodiment, the system/API (110) may include endpoints that allow other applications to communicate with the API (110) via a hypertext transfer protocol secure (HTTPS) protocol. Further, the system (110) may monitor model drifts in the trained models generated by the ML engine.

In an exemplary embodiment, the system (110) may use a batch and an online mode of model serving, i.e. process the one or more request from the users (102). In a batch mode, the system (110) may process a huge volume of data at a scheduled time and provide an output. In an online mode, the system (110) may enable other applications to obtain a faster output within a short period of time based on a processing of input data provided by the applications.

In an embodiment, the system (110) may use a versioning logic mechanism to ensure that a latest updated model among the one or more trained models may be utilized by the ML engine (108) for data processing. Further, the system (110) may determine at least recently used trained model from the one or more trained models for processing the one or more requests from the users (102). Further, the system (110) may unload a plurality of least used models from the one or more trained models based on the received one or more requests.

In an embodiment, the system (110) may use a caching mechanism to optimize a memory space associated with the memory of the system (110) by selectively loading the at least recently used trained model. The memory space may be a random access memory (RAM). In an embodiment, the system (110) may use a least recently used (LRU) technique as the caching mechanism to optimize the memory of the system (110). The system (110) may determine, using the LRU technique, the recently used trained model from the one or more trained models.

In an exemplary embodiment, the LRU technique may remove the least recently used models from the memory of the system (110) while making space for a newly requested model. Further, if a newly requested model is already present in memory, the LRU technique may bring the newly requested model to the top for processing the one or more requests from the user (102).

In an embodiment, the system (110) may predict resource data via the recently used trained model from the one or more trained models and enable the data processing based on the predicted resource data.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

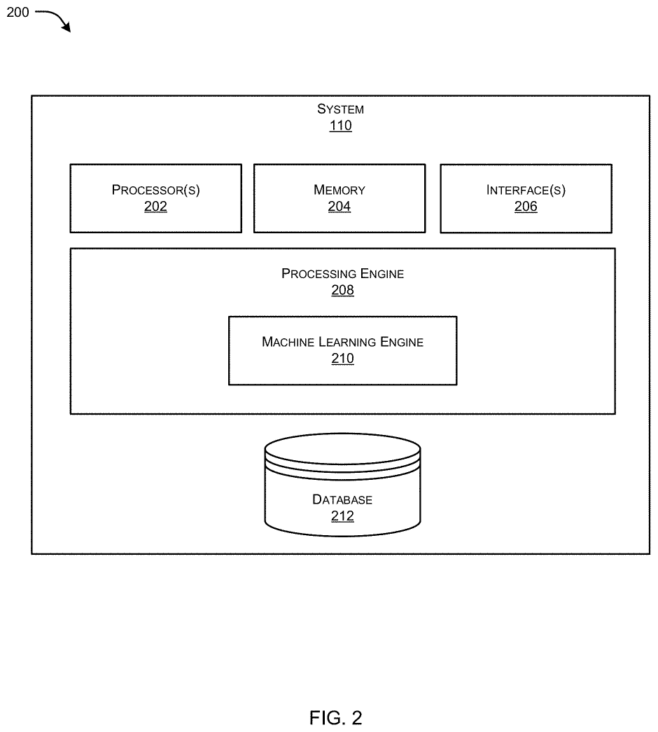

FIG. 2 illustrates an exemplary block diagram (200) of a proposed system (110), in accordance with an embodiment of the present disclosure.

Referring to FIG. 2, the system (110) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (110). Examples of such components include, but are not limited to, processing engine(s) (208), a ML engine (210), and a database (212). An ordinary person skilled in the art may understand that the ML engine (210) of FIG. 2 may be similar to the ML engine (108) of FIG. 1 in its functionality.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

In an embodiment, the processor (202) may receive one or more requests from one or more computing devices (104). The users (102) may operate the computing devices (104). The received one or more requests may be based on a training of one or more models via the ML engine (210) operatively coupled to the processor (202). Further, the processor (202) may determine at least recently used trained model from one or more trained models and unload a plurality of least used models from the one or more trained models based on the received one or more requests. The processor (202) may use a versioning logic mechanism for predicting the at least recently used trained model from the one or more trained models and processing the received one or more requests.

In an embodiment, the processor (202) may utilize a caching mechanism to optimize a memory space associated with the memory (204) by selectively loading the at least recently used trained model. The memory space may be a random access memory (RAM) for recording the one or more trained models. The processor (202) may utilize a least recently used (LRU) technique as the caching mechanism to optimize the memory space. The processor (202) may predict resource data via the at least recently used trained model from the one or more trained models based on the optimized memory space. The processor (202) may enable the data processing based on the predicted resource data.

In an embodiment, the processor (202) may be configured with a base manager to enable a recording of the one or more trained models. One or more parallel processes may be configured with the processor (202) to utilize the one or more trained models. Further, the base manager may be configured to use a race condition avoidance solution in order to prevent a read or write operation of the one or more parallel processes in a directory.

In an embodiment, the processor (202) may be configured with a common loading functionality for loading the plurality of trained models. Further, the common loading functionality may be configured with a multi-processing lock to prevent the one or more parallel processes from utilizing the plurality of trained models simultaneously.

In an embodiment, the processor (202) may be configured with a conditional lock functionality to process at least a model in a successive order from the one or more trained models based on the received one or more requests.

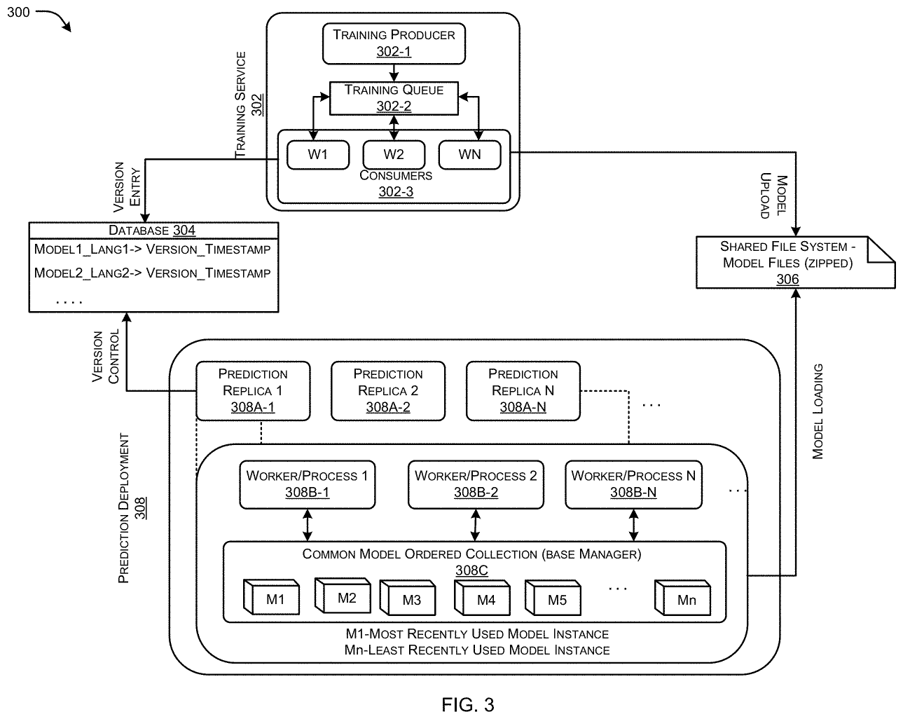

FIG. 3 illustrates an exemplary representation (300) of a high level architecture of an API, in accordance with an embodiment of the present disclosure.

As illustrated in FIG. 3, the high level architecture of the API may include a training service module (302), a database module (304) for version control, a shared file system module (306), and a prediction deployment module (308).

In an exemplary embodiment, the high level architecture (300) of the API may be designed to handle simultaneous requests for multiple models with a high throughput while efficiently using the available memory resources. The LRU technique based caching mechanism for models and a common loading system may be built to optimize the memory requirements of the system (110) without altering the throughput of the service provided by the system (110).

In an embodiment, the training service module (302) may further include a training producer (302-1), a training queue (302-2) and consumers (302-3). A person with ordinary skill in the art may understand that consumers (302-3) include but not limited to users (102) may provide one or more requests to the system (110). The prediction deployment module (308) may include a plurality of prediction replicas (308A-1, 308A-2 . . . 308A-n) operatively equipped with a plurality of worker processes/parallel processes (308B-1, 308B-2 . . . 308B-N). The plurality of models may be stored in the base manager (308C) which interchangeably specified as a common model ordered collection. The models (M1, M2 . . . MN) may be stored in the base manager (308C) in a successive order of model usage where M1 may be the most recently used model instance while Mn may be the least recently used model instance.

In an embodiment, the consumers (302-3) may provide one or more requests to the training service module (302). The training producer (302-1) may receive the one or more requests and form a queue (W1, W2 . . . WN) based on a priority of the one or more requests. The one or more requests may pertain to processing of one or more models by a ML engine (210).

In an embodiment, a version entry of the one or more models may be made in the database module (304) for version control. A model with the corresponding natural language processing (NLP) technique may be stored in the database module (304) with a version and a timestamp. Additionally, the models may be uploaded to the shared file system module (306) for further processing.

In an embodiment, the prediction deployment module (308) may have a plurality of worker/process/parallel processes (308B-1, 308B-2 . . . 308B-N) that may use a plurality of trained models. The base manager (308C) may include a plurality of trained models in a successive order (M1, M2 . . . Mn) to be utilized by the worker/process/parallel processes (308B-1, 308B-2 . . . 308B-N). The base manager (308C) may upload the plurality of trained models into the shared file system module (306). The plurality of prediction replicas (308A-1, 308A-2 . . . 308A-N) operatively coupled to the base manager (308C) may predict from most recently used trained model and unload a plurality of least recently used models from the plurality of trained models based on the one or more requests provided by the consumers (102). Further, the predicted recently used trained model may be updated with a version control and stored in the database module (304).

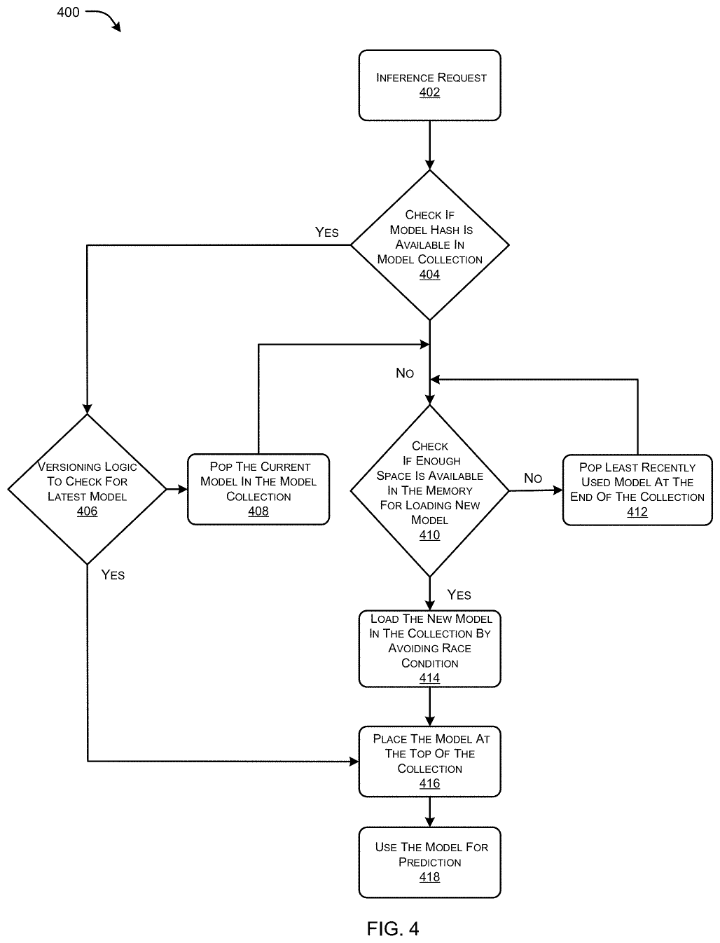

FIG. 4 illustrates an exemplary representation (400) of a flow diagram for a LRU caching mechanism, in accordance with an embodiment of the present disclosure.

As illustrated, the flow diagram for the LRU technique based caching mechanism may include inferencing a request at step 402. At step 404, the flow diagram may include checking if a model hash may be available in a model collection. If available, then at step 406, a versioning logic mechanism may be used to check for a latest model. If the latest model is not available then at step 408, the flow diagram may include the step of popping the current model in the model collection. At step (404), if the model hash may not be available in the model collection, then at step 410, a check may verify if enough space is available in the memory for loading a new model. If enough space is not available, then at step 412, a least recently used model may be popped at the end of the collection. If enough space is available, then at step 414, the new model may be loaded in the collection by an avoiding race condition. Further, the flow diagram at step 416 may include placing the model at the top of the collection as the most recently used model and at step 418 the model may be used for prediction.

In an exemplary embodiment, a memory calculation may be obtained at each prediction. The versioning logic mechanism may detect an updated model and the memory of the server may be calculated.
Total Memory: Memory of the server
Threshold Memory: Memory that can be used by the service from total memory
Maximum Model Size: Maximum size of the model that is possible
Memory to keep idle on server=Total Memory—Threshold Memory
Memory left on Server=Actual memory available on server—Memory to keep idle on server
If (Memory left on server>=Maximum Model Size):
   The model may be loaded
If (Memory left on server<Maximum Model Size):
   The LRU mechanism may unload the model(s) till the Maximum Model Size is not available
   Load the model

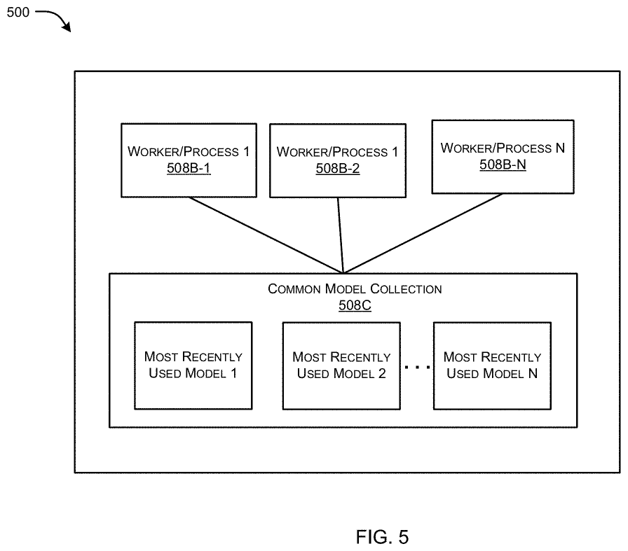

FIG. 5 illustrates an exemplary representation (500) of a flow diagram for a common loading functionality, in accordance with an embodiment of the present disclosure.

As illustrated in FIG. 5, the common loading functionality may consist of a plurality of worker/process (508B-1, 508B-2 . . . 508B-N) for sharing memory resources. By default, each of the worker/process (508B-1, 508B-2 . . . 508B-N) may have a replica of the model to generate the prediction request. Hence, a common model collection (508C) may be implemented such that a single/common model instance may be loaded onto the server and shared across the plurality of worker/process (508B-1, 508B-2 . . . 508B-N), thus enabling a process-based parallelism. In an exemplary embodiment, the common model collection (508C) may be used in conjunction with the LRU technique based caching system for a model, thus optimizing memory utilization. A multi-processing lock functionality may be used while loading the model in the collection such that the plurality of worker/process (508B-1, 508B-2 . . . 508B-N) may not load the model in the collection simultaneously.

In an exemplary embodiment, in order to facilitate the working of a multi-model prediction service deployed across multiple Kubernetes Pods, a set of instructions related to model loading mechanism may be developed. The set of instructions may utilize unique identifiers in the (zip) file of the shared file system module (306) as illustrated in FIG. 3 and minimize the possibility of a race condition, i,e one in 2.71 quintillion. The system (110) may also use a multi-processing lock functionality while performing loading operations in the model collection to prevent the incorrect loading of the model in the RAM.

In an embodiment, as inferencing on a single model may not support multi-threading, a conditional lock functionality may be used in such cases. When, two simultaneous requests arrive for a single model, the conditional lock functionality may be acquired for the model and two such requests may be served in succession. On the other hand, when two requests arrive simultaneously for different models, the conditional lock functionality may not be utilized.

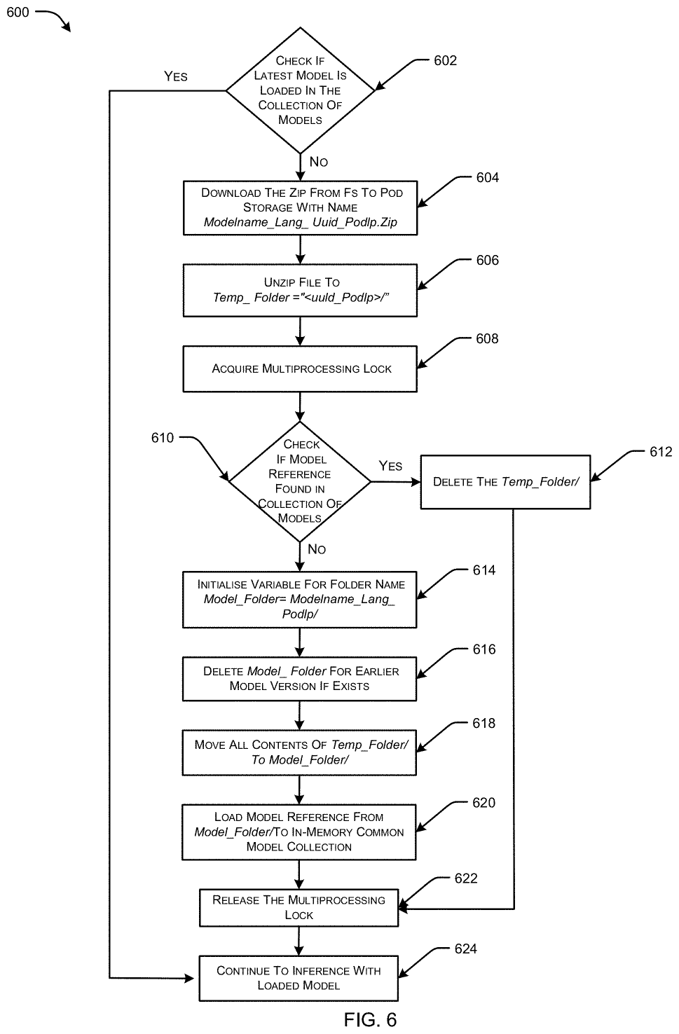

FIG. 6 illustrates an exemplary representation (600) of a flow diagram for a method depicting an execution process utilized by the API, in accordance with an embodiment of the present disclosure.

As illustrated in FIG. 6, the method may include a step 602 for checking if the latest model has been loaded in the collection of models. If yes, then at step 624, the loaded model may be inferenced for further processing. If the latest model has not been loaded, then at step 604, the model (zip) may be downloaded from a file system (FS) to Kubernetes pod storage with a name in the format modelname_lang_uuid_PodIP.zip. At step 606, the file may be unzipped to a temporary folder and provided with a unique user identification and the corresponding Pod ID (temp_folder=“<uuid>_<PodIP>/”). At step 608, the method may include the step of acquiring a multi-processing lock. At step 610, a check may be performed to observe if a model reference is found in the collection of models. If the model reference is found then the model reference may be deleted from the temp_folder and a multiprocessing lock may be released. If the model reference is not found, at step 614 a variable may be initialized with a folder name (model_folder=modelname_lang_uuid_PodIP). Further, at step 616, the model_folder for an earlier model version may be deleted upon existence. At step 618, all the contents of the temp_folder may be to the model_folder. At step 620, the model reference from the model_folder may be moved to an IN-Memory common model collection. Further, at step 624, the multiprocessing lock may be released and at step 624, the loaded model may be inferenced for further processing.

The present disclosure thus provides a unique and efficient LRU technique based caching mechanism that may keep the most recently used models into the RAM and avoid an extra delay while loading the new models. The base manager module may load heavy common objects that may be shared between multiple worker processes. Such an implementation may prevents an extra RAM usage, thus more models may be loaded into RAM for inferencing purposes. Further, the versioning logic mechanism may ensure that the latest/updated models may always be used for prediction. The version matching may be performed with the help of a database with minimal latency.

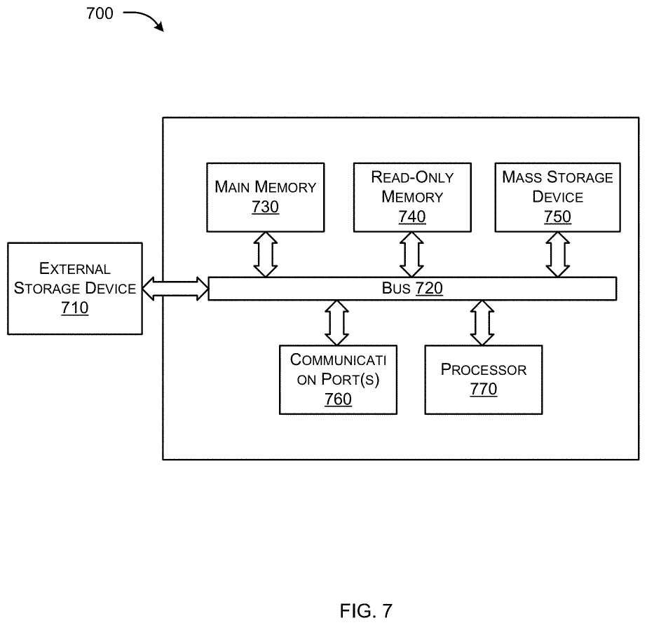

FIG. 7 illustrates an exemplary computer system (700) in which or with which the proposed system may be implemented, in accordance with an embodiment of the present disclosure.

As shown in FIG. 7, the computer system (700) may include an external storage device (710), a bus (720), a main memory (730), a read-only memory (740), a mass storage device (750), a communication port(s) (760), and a processor (770). A person skilled in the art will appreciate that the computer system (700) may include more than one processor and communication ports. The processor (770) may include various modules associated with embodiments of the present disclosure. The communication port(s) (760) may be any of an RS-232 port for use with a modem-based dialup connection, a 10/100 Ethernet port, a Gigabit or Gigabit port using copper or fiber, a serial port, a parallel port, or other existing or future ports. The communication ports(s) (760) may be chosen depending on a network, such as a Local Area Network (LAN), Wide Area Network (WAN), or any network to which the computer system (700) connects.

In an embodiment, the main memory (730) may be Random Access Memory (RAM), or any other dynamic storage device commonly known in the art. The read-only memory (740) may be any static storage device(s) e.g., but not limited to, a Programmable Read Only Memory (PROM) chip for storing static information e.g., start-up or basic input/output system (BIOS) instructions for the processor (770). The mass storage device (750) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (720) may communicatively couple the processor(s) (670) with the other memory, storage, and communication blocks. The bus (720) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (770) to the computer system (700).

In another embodiment, operator and administrative interfaces, e.g., a display, keyboard, and cursor control device may also be coupled to the bus (720) to support direct operator interaction with the computer system (700). Other operator and administrative interfaces can be provided through network connections connected through the communication port(s) (760). Components described above are meant only to exemplify various possibilities. In no way should the aforementioned exemplary computer system (700) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method to efficiently manage a random access memory (RAM) of a server by loading large files in a common base manager class instead of loading them into an each worker subprocesses.

The present disclosure provides a system and a method that utilizes a versioning logic mechanism that provides an updated machine learning (ML) model while serving an inference request. The Versioning logic will ensure the updated models are always used for prediction. Further, a version matching is done with the help of a database which is super-fast and avoids extra latency.

The present disclosure provides a system and a method that utilizes a least recently used (LRU) technique based caching mechanism which reduces an extra loading time by keeping most recently used model in the queue and prevents most used models from reloading.

The present disclosure provides a system and a method that utilizes a base manager class that loads heavy files altogether such that worker processes will contain small files, models that can be loaded rapidly. This base manager class implementation prevents an extra RAM usage by worker processes and hence more models may be loaded into RAM for inference purposes.

I/We claim:

1. A system (110) for resource prediction, the system (110) comprising:
a processor (202) operatively coupled with a memory (204), wherein said memory (204) stores instructions which when executed by the processor (202) causes the processor (202) to:
receive one or more requests from one or more computing devices (104), wherein one or more users (102) operate the one or more computing devices (104), and wherein the received one or more requests are based on a training of one or more models via a machine learning (ML) engine (108) operatively coupled to the processor (202);
determine at least a recently used trained model from the one or more trained models and unload a plurality of least used models from the one or more trained models based on the received one or more requests;
utilize a caching mechanism to optimize a memory space associated with the memory (204) by selectively loading the at least recently used trained model;
predict, via the at least recently used trained model from the one or more trained models, resource data based on the optimized memory space; and
enable the resource prediction based on the predicted resource data.

2. The system (110) as claimed in claim 1, wherein the processor (202) is configured to utilize a versioning logic mechanism to determine the at least recently used trained model from the one or more trained models and process the received one or more requests.

3. The system (110) as claimed in claim 1, wherein the processor (202) is configured to utilize a least recently used (LRU) technique as the caching mechanism to optimize the memory space.

4. The system (110) as claimed in claim 1, wherein the memory (204) is a random access memory (RAM) for storing the one or more trained models.

5. The system (110) as claimed in claim 1, wherein the processor (202) comprises a base manager to store one or more trained models, and enable one or more parallel processes to utilize the one or more trained models.

6. The system (110) as claimed in claim 1, wherein the processor (202) is configured with a common loading functionality for loading the one or more trained models.

7. The system (110) as claimed in claim 5, wherein the base manager is configured to use a race condition avoidance solution to prevent a read or write operation of the one or more parallel processes in a directory.

8. The system (110) as claimed in claim 6, wherein the common loading functionality is configured with a multi-processing lock functionality to prevent the one or more parallel processes from utilizing the one or more trained models simultaneously.

9. The system (110) as claimed in claim 1, wherein the processor (202) is configured with a conditional lock functionality to process, in a successive order, at least a model from the one or more trained models based on the received one or more requests.

10. A method for resource prediction, the method comprising:
receiving, by a processor (202), one or more requests from one or more computing devices (104), wherein the received one or more requests are based on a training of one or more models via a machine learning (ML) engine (108);
determining, by the processor (202), at least recently used trained model from the one or more trained models and unloading a plurality of least used models from the one or more trained models based on the received one or more requests;
utilizing, by the processor (202), a caching mechanism to optimize a memory space associated with a memory (204) of the processor (202), by selectively loading the at least recently used trained model;
predicting, by the processor (202), via the at least recently used trained model from the one or more trained models, resource data based on the optimized memory space; and
enabling, by the processor (202), the resource prediction based on the predicted resource data.

11. The method as claimed in claim 10, comprising utilizing, by the processor (202), a versioning logic mechanism for determining the least recently used trained model from the one or more trained models and processing the received one or more requests.

12. The method as claimed in claim 10, comprising utilizing, by the processor (202), a least recently used (LRU) technique as the caching mechanism to optimize the memory space.

13. The method as claimed in claim 10, comprising recording, by the processor (202), the one or more trained models, and enabling, by the processor (202), one or more parallel processes to utilize the one or more trained models.

14. The method as claimed in claim 10, comprising utilizing, by the processor (202), a common loading functionality for loading the one or more trained models.

15. The method as claimed in claim 13, comprising utilizing, by the processor (202), a race condition avoidance solution to prevent a read or write operation of the one or more parallel processes in a directory.

16. The method as claimed in claim 14, wherein the common loading functionality comprises a multi-processing lock functionality to prevent the one or more parallel processes from utilizing the one or more trained models simultaneously.

17. The method as claimed in claim 10, comprising utilizing, by the processor (202), a conditional lock functionality to process, in a successive order, at least a model from the one or more trained models based on the received one or more requests.

18. A user equipment (UE) (104) for resource prediction, the UE (104) comprising:
one or more processors communicatively coupled to a processor (202) in a system (110), wherein the one or more processors are coupled with a memory, and wherein said memory stores instructions which when executed by the one or more processors causes the one or more processors to:
transmit one or more requests to the processor (202) via a network (106), wherein the processor (202) is configured to:
receive the one or more requests from the UE (104), wherein the received one or more requests are based on a training of one or more models via a machine learning (ML) engine (108) operatively coupled to the processor (202);
determine at least recently used trained model from the one or more trained models and unload a plurality of least used models from the one or more trained models based on the received one or more requests;
utilize a caching mechanism to optimize a memory space associated with a memory (204) of the processor (202) by selectively unloading the at least recently used trained model;
predict, via the at most recently used trained model from the one or more trained models, resource data based on the optimized memory space; and
enable the resource prediction based on the predicted resource data.
